(19) United States
(12) Patent Application Publication
(10) Pub. No.: US 2021/0141891 A1
(43) Pub. Date: May 13, 2021

(54) IDENTIFYING SOFTWARE PROVENANCE

(71) Applicant: International Business Machines Corporation, Armonk, NY (US)

(72) Inventors: Thomas Weinzettl, Lilienfeld (AT); Phillip Adrian de Ridder, Dubai (AE)

(21) Appl. No.: 16/681,867

(22) Filed: Nov. 13, 2019

(51) Int. Cl. G06F 21/44; H04L 9/32

(52) U.S. Cl. CPC G06F 21/44; H04L 9/3213; H04L 9/3242

(57) ABSTRACT

A method, computer program product, and system for identifying provenance of a software product are provided. The method includes: (i) identifying a software product having a set of interdependent software components; (ii) for each software component of the set of interdependent software components, defining an associated verification record, wherein each verification record includes: a first verification value that verifies output data of the associated software component, and a second verification value that verifies input data of the associated software component; (iii) determining an authentication value for the software product based, at least in part, on output data of the software product; and (iv) verifying authenticity of the software product based, at least in part, on a comparison between the authentication value and a verification record associated with a software component of the software product.

### BACKGROUND

The present invention relates generally to the field of software, and more particularly to identifying software provenance.

When creating software products, it is common to rely on the use (e.g., include or incorporate) of pre-existing components (e.g., software libraries, components developed by third parties, open source code, or other externally-available software components). Such components may encapsulate specific and/or discrete functionality that is portable and reusable across different software products.

Establishing the veracity or provenance of software developed using components typically requires establishing the veracity or provenance of each of the incorporated component parts. Conventional approaches to this track configuration changes and software deployment in order to establish a singular path of build and deployment through the development of the software. Other known approaches employ code-signing to confirm authenticity or provenance of an associated component. For instance, a software library component from a version control system or source code repository may use signatures to prove authenticity.

### SUMMARY

According to an aspect of the present invention, there is a method, computer program product and/or system, for identifying provenance of a software product, that performs the following operations (not necessarily in the following order): (i) identifying a software product having a set of interdependent software components; (ii) for each software component of the set of interdependent software components, defining an associated verification record, wherein each verification record includes: a first verification value that verifies output data of the associated software component, and a second verification value that verifies input data of the associated software component; (iii) determining an authentication value for the software product based, at least in part, on output data of the software product; and (iv) verifying authenticity of the software product based, at least in part, on a comparison between the authentication value and a verification record associated with a software component of the software product.

### BRIEF DESCRIPTION OF THE DRAWINGS

Preferred embodiments of the present invention will now be described, by way of example only, with reference to the following drawings, in which:

FIG. 1 illustrates the concept of associating verification records with the components of a software product, according to a proposed embodiment;

FIG. 2 is a simplified flow diagram of a method for identifying provenance of a software product, according to a proposed embodiment;

FIG. 3 illustrates generation of verification values, according to a proposed embodiment;

FIG. 4 illustrates exemplary dependencies of chained verification values, according to a proposed embodiment;

FIG. 5 is a simplified flow diagram of a method for verifying authenticity of a software product having a provenance identified, according to a proposed embodiment;

FIG. 6 is a simplified flow diagram of another method for verifying authenticity of a software product having a provenance identified, according to a proposed embodiment;

FIG. 7 is a simplified flow diagram of yet another a method for verifying authenticity of a software product having a provenance identified, according to a proposed embodiment; and

FIG. 8 illustrates a system, according to a proposed embodiment.

### DETAILED DESCRIPTION

It should be understood that the Figures are merely schematic and are not drawn to scale. It should also be understood that the same reference numerals are used throughout the Figures to indicate the same or similar parts.

In the context of the present application, where embodiments of the present invention constitute a method, it should be understood that such a method may be a process for execution by a computer (i.e., may be a computer-implementable method). The various steps of the method may therefore reflect various parts of a computer program (e.g., various parts of one or more algorithms).

Also, in the context of the present application, a system may be a single device or a collection of distributed devices that are adapted to execute one or more embodiments of the methods of the present invention. For instance, a system may be a personal computer (PC), a server or a collection of PCs and/or servers connected via a network such as a local area network, the Internet and so on to cooperatively execute at least one embodiment of the methods of the present invention. Further, a component may be an integration flow that is executed by one or more processing units.

The use and combination of software components in complex software projects can make verification of the authenticity or validity of the overall code difficult and/or costly (in terms of required resources and time). This is particularly the case for languages which promote static linkage as well as packages of scripted languages. Conventional approaches for verifying authenticity/validity, or for establishing provenance, fail to validate the overall authenticity or provenance of deployed software products that have been developed using various embedded and/or interdependent components.

A software product may comprise (e.g., include, contain or incorporate) one or more components that encapsulate specific and/or discrete functionality. Such components may therefore be portable and/or reusable across different software products, and thus be provided as pre-existing components that are available for inclusion within a software product. For instance, components may be provided by proprietary and/or 3^{rd}-party software libraries, open source libraries, or other externally-available software components. By way of example, a software component employed in a software product may include one or more of the following: source code (in case of programing languages that require a compilation process) or executable scripts (e.g., JAVASCRIPT, REXX, PYTHON, PERL, TCL) of the current project, or pre-developed source code or executable scripts from the same project, other projects, or even imported source code or executable scripts from 3^{rd} party or open source projects; metadata describing the build process (e.g., makefiles, ANT, linker scripts, package manager control files, control files for dependency management and importing of other projects); metadata used for deployment (e.g., a YAML, DOCKER receipts, deployment descriptors of JAVA projects, metadata in software package management systems, helm charts, etc.); a software library component, independent if that library is linked static or dynamic; an intermediate product (e.g., not linked object files, or not packaged binary files); supporting files (e.g., textual, graphical or other media files packaged with the final product in a single deployable unit); and XML configuration and assembly files. (Note: the term(s) “JAVASCRIPT,” “REXX,” “PYTHON,” “PERL,” “TCL,” “ANT,” “DOCKER,” and/or “JAVA” may be subject to trademark rights in various jurisdictions throughout the world and are used here only in reference to the products or services properly denominated by the marks to the extent that such trademark rights may exist.)

Proposed are concepts for identifying provenance (i.e., validity, authenticity or genuineness) of a software product comprising a plurality of interdependent components. Such concepts may include defining, for each component, an associated verification record for verifying provenance of the component. The verification record may include values for verifying input and output data from the associated component. For instance, a first value may be for verifying input data for the associated component, and a second value may be for verifying output data for the associated component. Proposed concepts may therefore support separate verification of input and output data for a component of a software product. This concept for verification of an associated component may then be ‘chained’ together across various interdependent components of a software product, thereby enabling verification of overall provenance of the software product.

Proposed embodiments may therefore employ a concept whereby compiled or scripted software code or packages have a history of provenance attached to them, and this may be derived from its constituent individual component parts (for which their validity or origin can also be established by providing for their individual veracity/validity in turn to be ascertained). Proposed approaches may therefore provide n−1 provenance information of n components, and due to the chaining of components and their associated verification records, may also provide the complete provenance information for the end product.

By way of example, the first verification value may comprise a hash code (HASH), and the second verification value may comprise a hash-based message authentication code (HMAC). Authenticity may therefore be established through a combination of HASH and HMAC functions.

For instance, in an embodiment, defining a verification record associated with a component may comprise: defining a first verification value of the verification record based on a hash function and output data of the component; and defining a second verification value of the verification record based on a hash function and input data of the component. The hash function may employ a secret key.

Some embodiments may comprise repeating, for each iteration of transforming an input of the software product to an output of the software product, the step of defining an associated verification record for each component.

Also, some embodiments may include the step of defining a verification token for verifying the first and second verification values of a verification record. By way of example, the verification token may comprise a verifiable HMAC (VHMAC). The VHMAC may use the HMAC of the second verification value as a key. A concept of chaining of history may thus be established through a third HMAC function.

Proposed concepts may identify every tool (i.e., component) producing a product or intermediate product in a software configuration or build process, and then identify the provenance of the identified products (or intermediate products) using associated verification records.

It will therefore be appreciated that there is proposed a concept of tracking and auditing provenance across multiple steps of a software configuration or build process by building history of provenance as a chain of hashes. Every single record may comprise a hash code that proves authenticity of output data, and may also comprise a HMAC code which proves both input data (as well as a tool used in the software configuration or build process).

Further, it is proposed that software products built during a build process may be verified as authentic and unmodified (outside of the build process) using a VHMAC (Verifiable HMAC) value which is for proving authenticity of all previous records (e.g., the hash and the HMAC codes associated with the various components of the software product).

Proposed embodiments may therefore provide concepts for verification of every component that produces a software product (or every intermediate product in a software configuration or software build process). A method and system may therefore be provided for identification of the provenance of a software product, along with its intermediate product in the build and deployment process. Embodiments may also enable concepts for tracking and auditing provenance across multiple steps of a software configuration or software build process. Furthermore, there may be provided a method and/or system for verifying that software products built during a software build process are authentic and were not modified outside of that process. Dynamic and/or automatic identification and/or verification of authenticity of a software product may therefore be provided by proposed embodiments.

For the purpose of illustration only, proposed embodiments may provide the following benefits/advantages: (i) audit-ability of software projects along their entire life cycle including deployments in cloud environments; (ii) provenance of open source projects incorporated into commercial applications, or commercially-used applications; and (iii) verification of a software programs that the claimed components are included in the final product.

By way of further explanation, the conventional development process of software applications may require the use of software components, and these are typically taken from component libraries that are provided separately from the development project. The product is therefore created from a combination of imported packages (i.e., software components) and developed code. The libraries or packages may be imported using a source code repository or version control system. However, as has already been noted in the background section above, this approach makes it difficult to verify the authenticity of the product without recreating it from its various software components (e.g., re-compilation of the source).

According to proposed embodiments, however, provenance information (in the form of verification records) is associated with the components of the software build and configuration management processes. Using such provenance information (i.e., verification records) and the output of a process, the provenance or authenticity of the developed software product can be identified and verified. In particular, by chaining the verification records together, the provenance of the original component, and the exact code that was used at build time can be established at the time of execution.

By way of example, FIG. 1 illustrates the concept of associating verification records with the components of a software product according to a proposed embodiment. Such records are ‘chained’ together by way of being configured to be interdependent. As shown in FIG. 1, the proposed embodiment includes source1 100₁, source2 100₂, verification records 105, repository1 110₁, repository2 120₁, version control system 125, file 130, source 132, script 134, resource 136, compiler 138, object1 140₁, object2 140₂, verification records 150, linker 155, executable 160, deliverable 165, package 170, deployment 175, execution environment 180, and package 185.

Creating Provenance Information

According to a conventional development processes, every step in the software build process reads iteratively one or many input files to create a new output (i.e., software product). However, as depicted in FIG. 2, proposed embodiments for identifying provenance of a software product, firstly read the provenance history of the input (operation 200). Then, for every iteration of transforming the input to the output, a process 210 of updating verification values is undertaken. Specifically, for every iteration of transforming the input to the output, the input data is read (operation 215) and a (second) verification value (e.g., HMAC value) is updated from the input data (operation 220). Then, after compilation (operation 225), a (first) verification value (e.g., HASH value) is updated from the output data (operation 230) and the object code is written (operation 235). This process 210 is repeated for each iteration of transforming the input to the output. In this way, every process step has its own key for producing the (second) verification value (e.g., HMAC value). Once the process 210 is completed for all iterations, the final verification values (e.g., HMAC value and HASH value) are written out (operation 240). Finally, the provenance history and (first) verification value (e.g., HASH value) are used to generate (in operation 245) a third verification value (e.g., VHMAC) with the second verification (e.g., HMAC value) as a key.

As it will be appreciated, every step in a conventional development process only needs the input data to process the output data. However, according to proposed embodiments, every process employs the input data as well as the provenance history to produce the output data and its provenance history. In some embodiments, such processes may also employ an internal key to convert input data to output data. This is illustrated in FIG. 3, which depicts the generation of verification values according to proposed embodiments.

In particular, referring to the example depicted in FIG. 3, the second verification value 305 (e.g., HMAC value) is calculated from the input data 310 and the secret key 315 of this process step (using a HMAC function 318), whereas the first verification value (e.g., HASH value) 320 is calculated from the output data (using a hash function 330). The first verification value (e.g., HASH value) in the last (i.e., most recent) history of the provenance data 335 (i.e., a combination of the preceding HASH, HMAC, and VHMAC), is used to generate the third verification value (e.g., VHMAC value) 340 using the current HMAC as a key and a VHMAC function 345. The resulting verification values (e.g., HASH, HMAC and VHMAC values) 350 are attached to the chain of historical provenance records. It is to be noted here that the depicted example employs a secret key, whereas other proposed embodiments need not do so. For example, in some embodiments, an external tool may be used to create the HASH, HMAC, and VHMAC values. In such an embodiment, one of the inputs to the creation of the HASH, HMAC, and VHMAC may include a binary fingerprint of the tool/process used to convert input data to output data so as to ensure its authenticity.

Thus, according to proposed embodiments, a history of provenance is built as a chain of verification values (such as hashes). By way of further explanation of this concept, FIG. 4 illustrates exemplary dependencies of chained verification values according to a proposed embodiment.

A single verification record 400 comprises: (i) a hash value 410, that proves authenticity of output data 325; (ii) a HMAC value 415, that proves both input data 310 as well as the tool used in the process; and (iii) a VHMAC (Verifiable HMAC) value 420, that proves all the previous/preceding record in the chain of verification records, the HASH value of the verification record and the HMAC value of the verification record.

Verifying Provenance

Referring now to FIG. 5, there is depicted a simplified flow diagram of a method for verifying authenticity of a software product having a provenance identified according to a proposed embodiment. The method begins with reading (i.e., determining) an output of the software product (operation 500). An authentication value is then determined in operation 510 based on output data of the software product. In particular, in operation 510, a hash value is calculated based on the output of the software product. The determined authentication value (e.g., hash value) is then compared in operation 520 with that of the last verification record of the software product. Authenticity of the software product is then determined based on the comparison result. Specifically, if the values do not match, the method determined the output file of the software product to not be authentic in operation 525. Conversely, if the hash codes match, the output file is determined to be authentic in operation 530.

Referring now to FIG. 6, there is depicted a simplified flow diagram of a method for verifying authenticity of a software product having a provenance identified according to a proposed embodiment. Here, the HMAC record in the provenance history is verified. For this, the tool used to produce the output, as well as the input data is required. The tool will have its specific secret key embedded. Using the input data and the tool's secret key (retrieved in operations 600 and 605), the HMAC is recreated (e.g., calculated) in operation 610. The determined authentication value (e.g., HMAC) is then compared in operation 615 with that of the last verification record of the software product. Authenticity is then determined based on the comparison result. Specifically, if the newly created HMAC and the HMAC in the history record do not match, the method determines the input data and use of the specific tool are determined to not be authentic (operation 620). Conversely, if the newly created HMAC and the HMAC in the history record do match, the input data and use of the specific tool are determined to be authentic (operation 625).

Referring now to FIG. 7, there is depicted a simplified flow diagram of a method for verifying authenticity of a software product having a provenance identified according to a proposed embodiment. Here, the VHMAC record in the provenance history is used to verify authenticity. Specifically, by calculating the VHMAC in operation 710 from one verification record's HASH and HMAC (obtained in operations 700 and 705), the authenticity can be verified. The determined authentication value (e.g., VHMAC) is then compared in operation 715 with that of the last verification record of the software product. Authenticity is then determined based on the comparison result. Specifically, if the newly created VHMAC and the VHMAC in the history record do not match, the method determines the product to not be authentic (operation 720). Conversely, if the newly created VHMAC and the VHMAC in the history record do match, product is determined to be authentic (operation 725).

Embodiments may comprise a computer system 70, which may form part of a networked system 7, illustrated in FIG. 8. For instance, a verification record generator according to an embodiment may be implemented in the computer system 70 (e.g., as a processing unit 71). The components of computer system/server 70 may include, but are not limited to, one or more processing arrangements, for example comprising processors or processing units 71, a system memory 74, and a bus 90 that couples various system components including system memory 74 to processing unit 71.

System memory 74 can include computer system readable media in the form of volatile memory, such as random access memory (RAM) 75 and/or cache memory 76. Computer system/server 70 may further include other removable/non-removable, volatile/non-volatile computer system storage media in storage system 77. In such instances, each can be connected to bus 90 by one or more data media interfaces. The memory 74 may include at least one program product having a set (i.e., at least one) of program modules that are configured to carry out the functions of proposed embodiments. For instance, the memory 74 may include a computer program product having program executable by the processing unit 71 to cause the Input/Output (I/O) interface 72 perform a method for for identifying provenance of a software product comprising a plurality of interdependent components according to a proposed embodiment. Program/utility 78, having a set (at least one) of program modules 79, may be stored in memory 74. Program modules 79 generally carry out the functions and/or methodologies of proposed embodiments for partial write operations to memory.

Computer system/server 70 may also communicate with one or more external devices 80 such as a keyboard, a pointing device, a display 85, etc.; one or more devices that enable a user to interact with computer system/server 70; and/or any devices (e.g., network card, modem, etc.) that enable computer system/server 70 to communicate with one or more other computing devices. Such communication can occur via Input/Output (I/O) interfaces 72. Still yet, computer system/server 70 can communicate with one or more networks such as a local area network (LAN), a general wide area network (WAN), and/or a public network (e.g., the Internet) via network adapter 73.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a storage class memory (SCM), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, Python, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions. These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

### Definitions

Present invention: should not be taken as an absolute indication that the subject matter described by the term “present invention” is covered by either the claims as they are filed, or by the claims that may eventually issue after patent prosecution; while the term “present invention” is used to help the reader to get a general feel for which disclosures herein are believed to potentially be new, this understanding, as indicated by use of the term “present invention,” is tentative and provisional and subject to change over the course of patent prosecution as relevant information is developed and as the claims are potentially amended.

Embodiment: see definition of “present invention” above—similar cautions apply to the term “embodiment.”

and/or: inclusive or; for example, A, B “and/or” C means that at least one of A or B or C is true and applicable.

Including/include/includes: unless otherwise explicitly noted, means “including but not necessarily limited to.”

Computer: any device with significant data processing and/or machine readable instruction reading capabilities including, but not limited to: desktop computers, mainframe computers, laptop computers, field-programmable gate array (FPGA) based devices, smart phones, personal digital assistants (PDAs), body-mounted or inserted computers, embedded device style computers, application-specific integrated circuit (ASIC) based devices.

What is claimed is:

1. A computer-implemented method comprising:
identifying a software product having a set of interdependent software components;
for each software component of the set of interdependent software components, defining an associated verification record, wherein each verification record includes: (i) a first verification value that verifies output data of the associated software component, and (ii) a second verification value that verifies input data of the associated software component;
determining an authentication value for the software product based, at least in part, on output data of the software product; and
verifying authenticity of the software product based, at least in part, on a comparison between the authentication value and a verification record associated with a software component of the software product.

2. The computer-implemented method of claim 1, wherein the first verification value includes a hash code, and wherein the second verification value includes a hash-based message authentication code (HMAC).

3. The computer-implemented method of claim 2, wherein defining the associated verification record for a software component comprises:
defining the first verification value of the verification record based, at least in part, on a hash function and on the output data of the software component; and
defining the second verification value of the verification record based, at least in part, on the hash function on and the input data of the software component.

4. The computer-implemented method of claim 3, wherein the hash function employs a secret key.

5. The computer-implemented method of claim 2, further comprising:
defining a verification token, wherein the verification token verifies the first verification value and the second verification value of a verification record.

6. The computer-implemented method of claim 5, wherein the verification token includes a verifiable HMAC (VHMAC).

7. The computer-implemented method of claim 6, wherein the VHMAC uses the HMAC of the second verification value as a key.

8. The computer-implemented method of claim 1, further comprising:
for each iteration of transforming an input of the software product to an output of the software product, repeating the defining of the associated verification record for each software component.

9. The computer-implemented method of claim 1, wherein determining the authentication value for the software product includes calculating a hash value based on a hash function and on the output data of the software product.

10. A computer program product comprising a computer readable storage medium having program instructions embodied therewith, the program instructions executable by a processing unit to cause the processing unit to perform a method comprising:
identifying a software product having a set of interdependent software components;
for each software component of the set of interdependent software components, defining an associated verification record, wherein each verification record includes: (i) a first verification value that verifies output data of the associated software component, and (ii) a second verification value that verifies input data of the associated software component;
determining an authentication value for the software product based, at least in part, on output data of the software product; and
verifying authenticity of the software product based, at least in part, on a comparison between the authentication value and a verification record associated with a software component of the software product.

11. The computer program product of claim 10, wherein the first verification value includes a hash code, and wherein the second verification value includes a hash-based message authentication code (HMAC).

12. The computer program product of claim 11, wherein defining the associated verification record for a software component comprises:
defining the first verification value of the verification record based, at least in part, on a hash function and on the output data of the software component; and
defining the second verification value of the verification record based, at least in part, on the hash function on and the input data of the software component.

13. The computer program product of claim 12, wherein the hash function employs a secret key.

14. The computer program product of claim 11, the method further comprising:
defining a verification token, wherein the verification token verifies the first verification value and the second verification value of a verification record.

15. The computer program product of claim 14, wherein the verification token includes a verifiable HMAC (VHMAC).

16. The computer program product of claim 15, wherein the VHMAC uses the HMAC of the second verification value as a key.

17. A computer system comprising:
a processing unit; and
a computer readable storage medium having program instructions embodied therewith;
wherein the program instructions are executable by the processing unit to cause the processing unit to perform a method comprising:
identifying a software product having a set of interdependent software components;
for each software component of the set of interdependent software components, defining an associated verification record, wherein each verification record includes: (i) a first verification value that verifies output data of the associated software component, and (ii) a second verification value that verifies input data of the associated software component;
determining an authentication value for the software product based, at least in part, on output data of the software product; and
verifying authenticity of the software product based, at least in part, on a comparison between the authentication value and a verification record associated with a software component of the software product.

18. The computer system of claim 17, wherein the first verification value includes a hash code, and wherein the second verification value includes a hash-based message authentication code (HMAC).

19. The computer system of claim 18, wherein defining the associated verification record for a software component comprises:
defining the first verification value of the verification record based, at least in part, on a hash function and on the output data of the software component; and
defining the second verification value of the verification record based, at least in part, on the hash function on and the input data of the software component.

20. The computer system of claim 19, wherein the hash function employs a secret key.
